(19) United States
(12) Patent Application Publication
(10) Pub. No.: US 2007/0299158 A1
(43) Pub. Date: Dec. 27, 2007

(54) Inkjet inks with encapsulated colorants

(76) Inventor: Hiu Liu, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/473,923

(22) Filed: Jun. 23, 2006

(51) Int. Cl. C09D 11/00

(52) U.S. Cl. 523/160; 523/161

(57) ABSTRACT

Encapsulated colorants and process for making the same. In particular, the present invention is directed to a polymer encapsulated pigment dispersion including at least one pigment dispersion as a seed. The pigment dispersion is stabilized by at least one surfactant. The pigment has a pigment surface having a first polarity. The encapsulated pigment dispersion further includes at least one monomer having a second polarity which is relatively higher than the first polarity. The monomer is polymerized around the pigment surface.

### FIELD OF THE INVENTION

The present invention generally relates to ink-jet printing, and in particular, to inkjet inks and ink sets with improved print quality performance, and method for making the same.

### BACKGROUND OF THE INVENTION

The use of imaging systems have experienced significant improvements and are increasing in popularity. The growth may be attributed to substantial improvements in digital image capturing devices such as digital cameras and improvements in digital image-forming apparatus (e.g., inkjet printers including thermal and piezo, laser printers, silver halide grade photo imaging apparatus) such as print resolution and overall print quality coupled with appreciable reduction in cost, and ease of use. With such growth, professional and personal consumers have captured and printed more images.

The inks used in various ink jet printers can be classified as either dye-based or pigment-based. A dye is a colorant which is molecularly dispersed or dissolved in a carrier medium such that discrete colorant particles cannot be observed. The carrier medium can be a liquid or a solid at room temperature. In pigment-based inks, the colorant exists as discrete particles suspended in a carrier medium. These pigment particles are usually treated with dispersants or stabilizers which keep the pigment particles from agglomerating and/or settling out of suspension. One of the challenges is the collection and bringing together of printed images in easy to manage systems and formats.

Ideally, the ink used in an inkjet printing system should meet various performance parameters. These parameters may include certain physical properties of the ink such as viscosity, surface tension, and electric conductivity that work well with the discharging conditions of the inkjet print head, such as the driving voltage and driving frequency of the ink discharge means in the print head, the form and material of print head discharge orifices, the diameter of the orifices, etc. The ink should also be able to remain in storage for prolonged periods of time without causing subsequently clogging or other complications in the print head. The ink should not chemically attack, corrode or erode surrounding materials such as the ink storage container, print head components, etc. The ink should be non-toxic, flame-resistant and without any unpleasant odor. The ink should also exhibit low foaming and high pH stability characteristics.

The ink should be quickly fixable onto a print medium such that an image formed appears smooth without revealing the individual drops of ink used to form the image. Once formed into the desired image on the print medium, the ink should have strong water resistance and light resistance, meaning that the image will resist being degraded by exposure to either moisture or strong light. The ink of the printed image should also have high adhesion to the print medium and be resistant mechanical damage such as scratching.

In order to promote these desirable characteristics of an inkjet ink, specifically, a pigment-based ink, it has been suggested to encapsulate the colorant particles in a pigment-based ink. However, previous attempts to encapsulate colorant particles in a pigment-based inkjet ink so as to promote desired ink characteristics without otherwise degrading the ink's performance have met with very limited success.

It would be desirable to provide convenient and easy-to-use photo books and methods for creating the same, in particular for personal consumer market.

### SUMMARY

The present invention is directed to encapsulated colorants and process for making the same. In particular, the present invention is directed to a polymer encapsulated pigment dispersion including at least one pigment dispersion as a seed. The pigment dispersion is stabilized by at least one surfactant. The pigment has a pigment surface having a first polarity. The encapsulated pigment dispersion further includes at least one monomer having a second polarity which is relatively higher than the first polarity. The monomer is polymerized around the pigment surface.

### BRIEF DESCRIPTION OF THE DRAWINGS

FIG. 1 is a flowchart illustrating an exemplary method embodying features of the present invention.

FIG. 2 is an illustration of the dispersions having features of the present invention usable in the method of FIG. 1.

FIG. 3 is a graphic representation of the effect of the relative relationship between the monomers and pigment dispersions according to the present invention.

### DETAILED DESCRIPTION OF EMBODIMENTS OF THE INVENTION

In the following description, like reference numbers are used to identify like elements. Furthermore, the drawings are intended to illustrate features of exemplary embodiments in a diagrammatic manner. The drawings are not intended to depict every feature of actual embodiments nor relative dimensions of the depicted elements, and are not drawn to scale.

The encapsulation of pigment particles or colorant particles in a pigment-based ink has been of great interest for a long time because of the large potential improvement in the performance characteristics of an ink bearing successfully-encapsulated colorant particles. The encapsulation of pigment or colorant particles has also been broadly recognized as a potential means of simplifying ink formulation. The challenge has been to find a practical and relatively general method to encapsulate various pigment particles with excellent colloidal stability, high monomer conversion, high encapsulation efficiency, minimum free polymer remaining after encapsulation, flexibility to vary polymer types and ratios, practical scale up capability, and control over the morphology of the encapsulated pigments. This invention addresses one or more of these challenges, among others.

The present invention is directed to features of methods for encapsulating colorant particles, and encapsulated pigment dispersions and inks, including inkjet inks, made using the same.

A practical encapsulation process using semi-continuous emulsion polymerization, is described below, in part, in reference to the figures.

The encapsulation process described herein according to the present invention will significantly improve the performance characteristics of inks made using the same, particularly durability of the printed images (e.g., the smudge and water resistance) while maintaining and/or improving the print quality of the images (e.g., acuity).

Typically, in semi-continuous emulsion polymerization methods, the monomer is diffused, in an uninterrupted process, from the monomer droplets onto micelles. The diffused monomer/micelle structures later growing into larger particles. In contrast thereto, in the present method, the surfactant-stabilized pigment dispersion behaves as a seed. A polymer layer is built up around the pigment surface by a monomer first diffusing onto the pigment surface followed by subsequent polymerization at relatively high temperature. The monomers are supplied by continuous feeding of a preemulsion which is formed of emulsified monomer droplets in aqueous form.

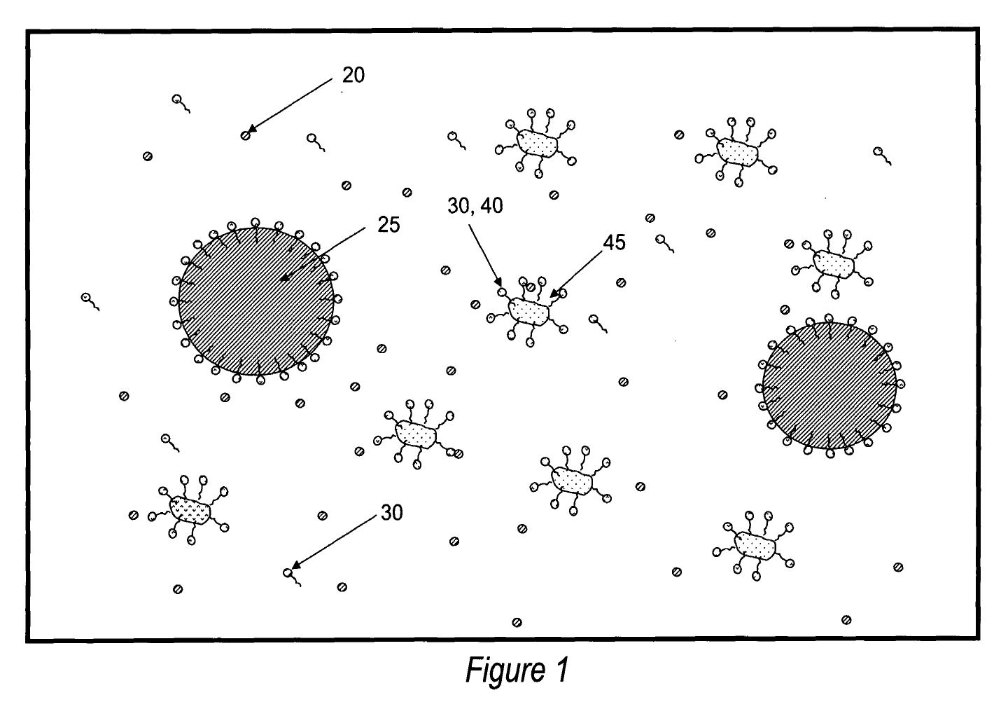

Now referring to FIG. 1, the features of an embodiment of the process of the present invention is generally illustrated showing the seeded semi-batch encapsulation process, embodying features of the present invention. In the embodiment shown, the pigment particles are used as seeds onto which monomers diffuse, with the occurrence of subsequent polymerization.

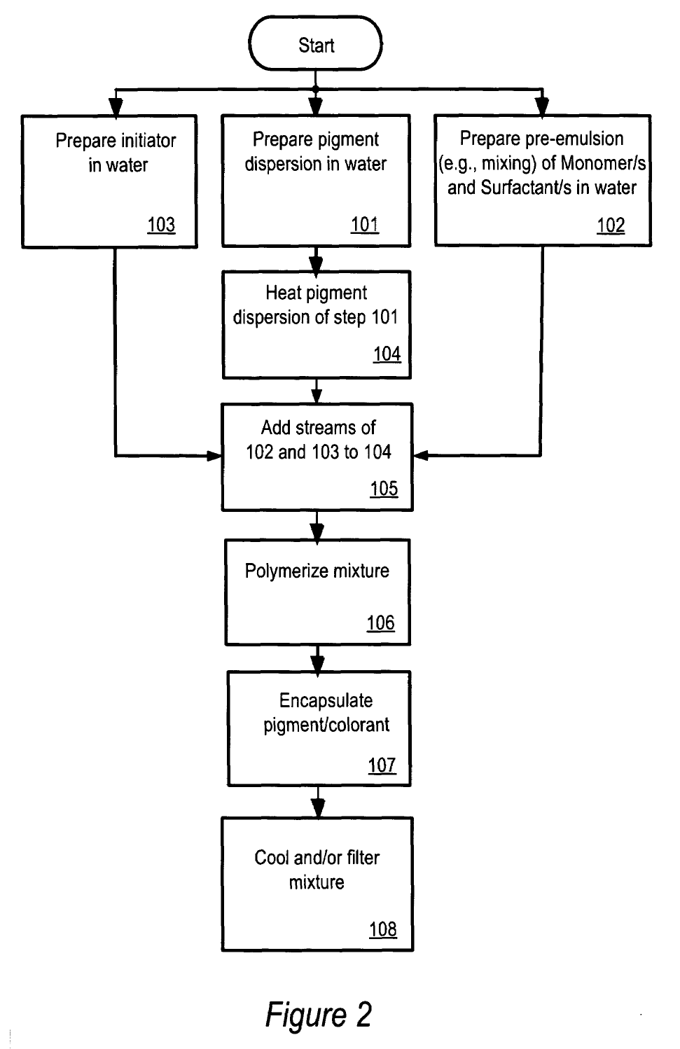

As shown, individual monomers 20 are stabilized into monomer droplets 25 by at least one suitable surfactant 30. An aqueous encapsulated pigment dispersion is prepared by using a suitable pigment dispersion 35 that is stabilized by at least one surfactant 40 (surfactants 30 and 40 may be similar or different). The surfactant-stabilized pigment dispersion behaves as a seed 45. The polymer layer is built up around the pigment surface by the monomer first diffusing onto the pigment surface followed by subsequent polymerization at relatively high temperature as described in reference to FIG. 2. The monomers are supplied by continuous feeding of a preemulsion which is formed of emulsified monomer droplets in aqueous form.

Now referring to FIG. 2, a pigment or colorant dispersion is prepared (step 101). In a second dispersion, at least one monomer is emulsified in water with at least one surfactant (step 102). Initiator/s are also prepared in water (103). The emulsification of the monomers typically results in a thick milky preemulsion. The pigment dispersion is heated to, preferably, a temperature ranging from about 50 to about 90 degrees Celsius (step 104). In an embodiment, the preemulsion is, preferably gradually, added to the pigment dispersion (step 105). This addition, preferably, is done over a period of time sufficiently long to allow for the monomers to polymerize onto or with the pigment dispersion. The initiator/s may be added directly in its entirety or gradually to the pigment dispersion mixture (step 106). The collective mixture of the pigment dispersion, preemulsion, and initiators, are, preferably maintained at the above temperature for a period of time, sufficiently long to, normally about one hour after all the preemulsion has been added, allow for the monomers to polymerize and encapsulate the pigment or colorant particles in the mixed dispersion. Thereafter, the reaction mixture allowed to cool down, and preferably, filtered (step 107).

This process will produce an ink with encapsulated pigment or colorant particles, with enhanced durability and resistance to environmental (e.g., water and light) and use factors (e.g., handling such as smudge resistance), while providing printed images with maintained or improved image quality. Preferably, the formulated inks will also have better colloidal stability, simpler manufacturing process, and better ability to modify surfaces and polymer and polymer morphologies for specific needs and better encapsulation efficiency with minimum to no free polymer and bare pigment.

Without intending to limit the scope of the present invention, in an embodiment of a process and or composition, having features of the present invention, one or more of the following conditions may be present:

Preferably, to produce a desired encapsulation morphology, preferably, the minimum interfacial energy principle should be satisfied. This will result in formulations that are thermodynamically stable. Consequently, there are some selection criteria for monomers and surfactants, as well as pigment surfaces.

The interfacial energy principle for, at leas substantially, spontaneous encapsulation may be stated mathematically as follows:

Y_{pigment/water}>Y_{pigment/monomer}

In an embodiment, the polarity of monomer preferably lies between that of the pigment and that of the water. In an embodiment, when the pigment surface is of relatively high polarity, preferably only monomers having a relatively higher polarity than that of the pigment may be used for encapsulation. Without intending to limit the scope of the invention, it was observed that when the polarity conditions are not met, the pigment/monomer system is unstable. The result is an encapsulated morphology having a minimum interfacial energy and being, therefore, in the most thermodynamically stable form. However, without intending to limit the scope of the invention, it was observed that in some instances pigment dispersions and free pigment particles may coexist stably. For example, magenta pigment PR122 with medium polarity may be successfully encapsulated by acrylic monomers, but encapsulation attempts with less polar styrene or methyl styrene monomers were not desirably successful.

In a separate example, attempts to encapsulate a very polar yellow pigment PY 155 with styrene appeared to be yield successful encapsulation, as evidenced by good stability and monomer conversion. But further SEM and capillary electrophoresis analysis indicated pigment particles were not being encapsulated, instead, separate free polymer particles were formed.

In an embodiment, the polarity of the monomer composition used is higher than that of the surface of the pigment or colorant particles. This is so that the interfacial energy between the polymer and water can be reduced. Non-polar monomers, such as styrene, were found to be not suitable for some pigment encapsulations.

In an embodiment, free micelle is substantially absent from the mixture, and alternatively or additionally, the total pigment surface area is, preferably, substantially greater than the micelle surface area. The greater pigment surface area will enable the diffusion of the monomer onto the pigment instead of the micelle, thus leading to none to minimal presence of free polymer. Another preferred condition is that the pigment surface is relatively and sufficiently non-polar. This relative non-polarity will enable the reduction of the total free energy of the system, leading to the diffusion step to be more spontaneous. Another preferred condition is substantial absence of reactive sites on the pigment surface. By way of example, in quinacridone-based pigments, the presence of very active hydrogen results in premature quenching of the polymerization process. In the event that such reactive groups are present on the pigment surface, their effect may be minimized, preferably, by the presence of other inactive groups such as synergists.

Exemplary monomers usable in the present invention include: any acrylic, vinyl acetate, styrene or other monomer that contains polymerizable double bonds. The surfactant may be one or more surfactants that include, for example, sodium dodecyl sulphate (SDS), dioctyl sodium sulfosuccinate (Aerosol OT), ABEX® (anionic surfactant), other anionic surfactants and any polymerizable surfactants. The surfactant for dispersing the pigment and the monomer may be the same or different.

In an embodiment, dispersed pigments, such as SDS-stabilized (“SDS” or sodium dodecyl sulphate) pigments may be encapsulated with any one or more of a range of surfactants, including SDS; Abex (a phenol Ethoxylate, generally available from companies such as Schibley Chemical Company, Inc. of Ohio), AOT (sodium bis-2-ethylhexyl-sulfosuccinate), Triton (a non-ionic octyl phenol ethoxylate surfactant), or mixtures thereof, preferably, as combined mixture for dispersing the pigment; Hitenol 10, 20, or 30, and other suitable polymerizable surfactants. Hitenol surfactants are based on polyoxyethylene alkylphenyl ether ammonium sulfate chemistry and is generally available from Dai-Ichi Kogyo Seiyaku Co., Ltd. of Japan, under the trademark of Hitenol; and generally having the following properties as shown in Table 1:

TABLE I

| | Grade | | | | |
|---|---|---|---|---|---|
| | HITENOL | HITENOL | HITENOL | HITENOL | HITENOL |
| | BC-10 | BC-1025 | BC-20 | BC-2020 | BC-30 |
| Appearance | Yellowish | Yellowish | Yellowish | Yellowish | Yellowish |
| | Brown | Brown | Brown | Brown | Brown |
| | viscous | viscous | viscous | viscous | viscous |
| | liquid | liquid | liquid | liquid | liquid |
| Effective | 97.0 | 24.0–26.0 | 97.0 | 19.0–21.0 | 97.0 |
| Matter (%) | Minimum | | Minimum | | Minimum |
| Volatile | 3.0 | 74.0–76.0 | 3.0 | 79.0–81.0 | 3.0 |
| Matter (%) | Maximum | | Maximum | | Maximum |
| pH | 6.5–8.5 | 6.5–8.5 | 6.5–8.5 | 6.5–8.5 | 6.5–8.5 |
| | (1% aq. | (1% aq. | (1% aq. | (1% aq. | (1% aq. |
| | soln.) | soln.) | soln.) | soln.) | soln.) |

Exemplary pigments suitable in the practice of the invention, include any surfactant-stabilized pigment, or polymeric dispersant stabilized pigment (e.g., such as SDS (sodium dodecyl sulphate) dispersions) having the characteristics stated above, including by way of example: Yellow H5G based on PY 213, a monazo/chinaazolondion pigment class; Cyan BG based on PB15, a Cu-phthaloblue class; and Magenta E based on PR122, a quinacridone pigment class. The SDS dispersed pigments Cyan BG, Yellow H5G, and Magenta E, are available from Clariant Corporation.

The surface of the dispersed pigments may be modified to the desired polarity using a number of processes such as, hydrolysis or other chemical reaction with molecules on the crystal surface to create more or less ions content; physically adsorbing an inert layer; co-crystallize with other small molecules; or any combinations thereof.

The monomer may be in the form of a simple monomer, one of core/shell structure (e.g., the monomer contents in these two layers can be different). The core/shell structure may be achieved in any of customary manners

Preferably, the amount of the free polymer and/or un-encapsulated pigment is kept to a minimum, generally below about 5% as measured by SEM and capillary electrophoresis.

The monomer to pigment ratio may range from about 0.05 to about 6, normally ranging from about is 0.2 to 2.

### EXAMPLES

By way of example, experiments were run, as described below, using various colorants and monomers to further evaluate the performance of pigments encapsulated according to the present invention.

Exemplary pigmented colorants used included: Magenta E-SDS having a relatively medium polarity; Yellow E-SDS and being relatively non-polar; Hostajet Yellow H5G SDS with a relatively non-polar surface; and Cyan E-ST having a relatively high polarity.

### Example 1

Forty two (42) grams (g) of pigment dispersion Hostajet Yellow H5G SDS, available from Clariant, and having a relatively non-polar surface, and ninety (90) grams of deionized water were charged into a five hundred milliliter (500 ml) round bottom three-neck flask. In a separate flask, a thick milky preemulsion was prepared by intensely mixing the following monomers and surfactants: 20 g of methyl methacrylate (MMA), 0.3 g of methacrylic acid (MAA), 8 g of deionized water, 1.7 g of Igepal 897 and 1.0 g of Abex EP110. In a separate feeding stream, water soluble initiator, a potassium persulfate solution was prepared by dissolving 0.7 g of potassium persulfate in 30 g of deionized water.

The flask including the pigment dispersion was heated to 82° C. (degrees Celsius), and using syringe pumps, the two streams of preemulsion and initiator solution were added to the pigment dispersion flask/reactor over a two hundred (200) minute time period. The reaction mixture was held for another hour after the completion of the feeding period. The mixture was then let cool down, and was thereafter filtered through one (1) micron filter. The

Monomer Polarity

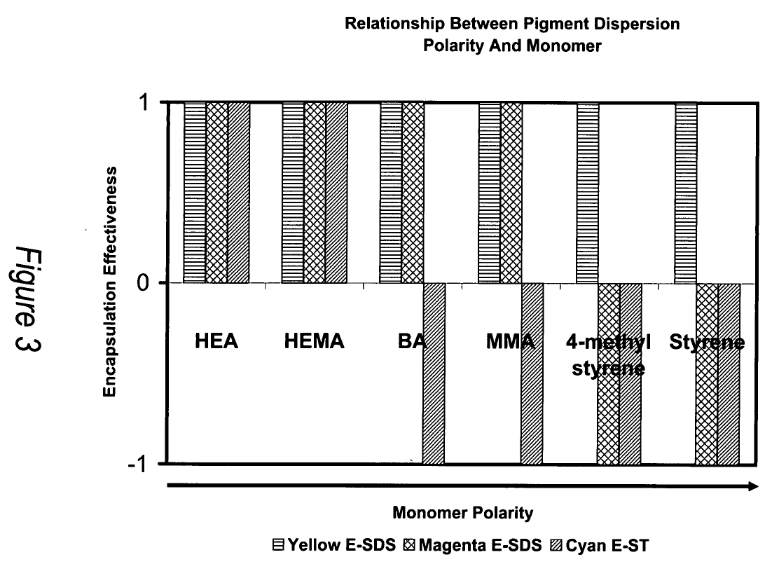

Monomers with different polarity were used to encapsulate colorants having different levels of relative polarity in order to further evaluate the performance of pigments encapsulated according to the present invention; the results of which are shown in FIG. 3.

The exemplary monomers included, in order of increasing polarity, styrene, 4-methyl styrene, methyl methacrylate (MMA), butyl acrylate (BA), hydroxyethyl methacrylate (HEMA), and hydroxylethlyacrylate (HEA).

As also noted above, surfactant systems for the pigment dispersion and monomer preemulsion should be sufficiently matching, which means the surface tensions, surfactant types and concentrations of both dispersions should be matched. If the surfactant systems are not sufficiently matched, there may be some surfactant redistribution causing dispersion instabilities.

As can be seen, colorants having higher polarity relative to the monomers used, showed better encapsulation performance (with −1 and +1 indicating poor and good encapsulation, respectively). For example, as can be attempts at encapsulating Magenta E-SDS with relatively non-polar monomers, such as 4-methyl styrene, resulted in poor encapsulation performance while, encapsulation with more polar monomers, such as methyl methacrylate, n-butyl acrylate and their mixtures resulted in highly and consistently successful performance. With another very non-polar pigment, e.g., the Yellow dispersion, all the monomers, styrene and acrylics, resulted in good encapsulation performance.

Various analytical techniques were used to assess the effectiveness of the encapsulation process, including, but not limited to, SEM for detecting presence of free polymer; Tunneling Electron Microscopy (TEM) and Capillary Electrophoresis (CE) to confirm encapsulation.

By way of summarization, and not limitation, the following monomers were successfully used to encapsulate the various pigments: styrene, 4-methyl styrene, MMA, BA, MA, BMA, HEMA, Acrylamide, and HEA, to encapsulate Yellow E-SDS pigment particles; MMA, BA, HEMA and HEA to encapsulate Magenta E-SDS pigment particles; HEMA and HEA to encapsulate Cyan E-ST pigment particles. When a nonpolar cyan pigment BG-SDS was used a wider range of monomer is usable, a wider variety of monomers including acrylics can be used for encapsulations.

These results are due to the relative polarity between the monomer and the surface the of pigment particle being encapsulated.

Conversion rates were generally greater than 90%. Free polymer presence as determined by SEM was generally less than 5%. The products showed good colloidal stability and were printable with satisfactory image quality. Much improved smudge resistance was found on nonporous media.

Various colored inkjet inks were prepared using the above process, including cyan, yellow, and magenta pigmented color inks.

Generally, based on the total weight of the pigment dispersion, the pigment dispersion, may contain, independently, 5% by weight pigment and 5% by weight of free polymer. Generally, based on the total weight of the ink, the ink, may contain about 2% to 4% by weight pigment.

The features of the process described herein is applicable to many ink formulations, variation in the types and amounts of monomers used, with any suitable pigment color being capable of being encapsulated. The resulting inks are printable with high quality results and also demonstrate great durability.

While particular forms of the invention have been illustrated and described herein, it will be apparent that various modifications and improvements can be made to the invention. Moreover, individual features of embodiments of the invention may be shown in some drawings and not in others, but those skilled in the art will recognize that individual features of one embodiment of the invention can be combined with any or all the features of another embodiment. Accordingly, it is not intended that the invention be limited to the specific embodiments illustrated. It is intended that this invention to be defined by the scope of the appended claims as broadly as the prior art will permit.

What is claimed is:

1. A polymer encapsulated pigment dispersion, comprising:
a. at least one pigment dispersion as a seed and stabilized by at least one surfactant, the pigment having a pigment surface with a first polarity;
b. at least one monomer having a second polarity relatively higher than the first polarity and having been polymerized around the pigment surface.

2. The encapsulated pigment dispersion of claim 1, wherein the at least one polymer is diffused onto the seed pigment dispersion.

3. The encapsulated pigment dispersion of claim 1, wherein the pigment surface is substantially free of reactive sites.

4. The encapsulated pigment dispersion of claim 1, wherein the encapsulated pigment dispersion is present in an ink.

5. The encapsulated pigment dispersion of claim 4, wherein the ink is an inkjet ink.

6. The encapsulated pigment dispersion of claim 5, wherein the pigment generally imparts hues selected from the group yellow, magenta, and cyan.

7. The encapsulated pigment dispersion of claim 5, wherein the pigment is a monazo/chinaazolondion based yellow pigment selected from the group consisting of PY 213 and Yellow H5G.

8. The encapsulated pigment dispersion of claim 5, wherein the pigment is a quinacridone based magenta pigment selected from the group consisting of Magenta E and PR122.

9. The encapsulated pigment dispersion of claim 5, wherein the pigment is a copper-phthaloblue based cyan pigment selected from the group consisting of Cyan BG and PB15.

10. The encapsulated pigment dispersion of claim 1, wherein the polymerized monomer encapsulating the pigment has a core/shell structure.

11. The encapsulated pigment dispersion of claim 1, wherein the substantially all of the monomer has been polymerized encapsulating the pigment.

12. The encapsulated pigment dispersion of claim 1, wherein substantially all the pigment is encapsulated.

13. The encapsulated pigment dispersion of claim 1, wherein the composition of the pigment dispersion charged generally includes about five percent (5%) pigment and about five percent (5%) monomer, on a weight basis of the total pigment dispersion as charged.

14. The encapsulated pigment dispersion of claim 4, wherein, the ink contains about one (1) to about five (5) wt. % pigment on a weight basis as compared to the total weight of the ink.

15. A process for making an encapsulated pigment dispersion, comprising:
a. providing at least one pigment dispersion as a seed and stabilized by at least one first surfactant, the pigment having a pigment surface with a first polarity;
b. combining the pigment dispersion with water in a first container;
c. providing at least one monomer having a second polarity relatively higher than the first polarity;
d. emulsifying the at least one monomer with a second surfactant into a preemulsion in a second container;
e. providing at least one aqueous initiator in a third container;
f. heating the first container to a first temperature;
g. adding the preemulsion to the pigment dispersion over a first time period;
h. adding the initiator to the pigment dispersion mixture over a second time period;
i. maintaining a mixture of the pigment dispersion, preemulsion, and initiator, at the first temperature for a third period of time;

16. The process of claim 9, further comprising:
a. letting the mixture of the pigment dispersion, preemulsion, and initiator to cool to a second temperature.

17. The process of claim 9, further comprising:
a. filtering the mixture of the pigment dispersion, preemulsion, and initiator.

18. The process of claim 15, wherein the process is a semi-batch polymerization process.

19. The process of claim 15, wherein the process is a mini-emulsion polymerization process.

20. The process of claim 15, wherein the monomer to pigment ratio ranges from about 0.05 to about 6.

21. The process of claim 15, wherein the monomer to pigment ratio ranges from about 0.2 to about 2.
